(19) United States
(12) Patent Application Publication
(10) Pub. No.: US 2015/0104609 A1
(43) Pub. Date: Apr. 16, 2015

(54) PROTECTIVE COVER FOR A PORTABLE OR MOBILE DEVICE

(71) Applicant: Speculative Product Design, LLC, Mountain View, CA (US)

(72) Inventors: Randy Chiang, San Jose, CA (US); David Lean, San Francisco, CA (US); Eric Frasch, San Francisco, CA (US); Bryan Day, San Jose, CA (US)

(21) Appl. No.: 14/491,185

(22) Filed: Sep. 19, 2014

Related U.S. Application Data
(60) Provisional application No. 61/880,804, filed on Sep. 20, 2013.

(51) Int. Cl. G06F 1/16; B32B 38/00; B32B 37/30; B32B 38/04

(52) U.S. Cl. CPC G06F 1/169; G06F 1/1607; B32B 38/04; B32B 38/0012; B32B 37/30; B32B 2038/047
USPC 428/138; 428/213; 156/253; 156/221

(57) ABSTRACT

A cover device for a portable or mobile device, in particular for mobile phones, having a section configured to allow touch identification technology—such as fingerprint identification—already built into the portable device to work properly.

### CROSS-REFERENCE TO RELATED APPLICATIONS

This application is related to pending U.S. provisional patent application No. 60/880,804, filed Sep. 20, 2013, and titled “PROTECTIVE COVER FOR A PORTABLE OR MOBILE DEVICE,” the entirely of which is incorporated herein by reference.

### DESCRIPTION OF THE RELATED ART

The invention is directed to a cover device for a portable or mobile device, in particular for mobile phones and tablets, having a section configured to allow touch identification technology—such as fingerprint identification—already built into the portable device to work properly. An independent screen protector, or a case with screen protection, is provided that features a thinner zone/area to allow for touch identification (e.g., fingerprint scanning) on portable of mobile device (e.g., a phone or tablet device). This includes inserting a thin piece of film over just the button area, applying a thin film over the entire screen protector except over the screen area, and using forming tools to thin out the button area.

It is noted that citation or identification of any document in this application is not an admission that such document is available as prior art to the present invention.

Some portable devices now have touch identification technology built into the device so that a user can log into, or turn on, the device without having to enter a password or passcode. For example, the iPhone 5s now has a feature built into it called Touch ID, which includes a fingerprint identity sensor. With the iPhone 5s, a user can simply put a finger on the Home button and click, and the iPhone 5s unlocks.

With portable devices—especially mobile phones such as the iPhone 5s—it is advantageous to provide full coverage of the front surface of the device. Current cases with screen protection and individually sold screen protectors either feature a die cut hole around buttons (such as the Home button on an iPhone device) or they feature a formed piece of film or rubber overmold to cover the buttons. But in portable devices with touch identification technology, current films either prevent the touch identification sensors from operating properly—including films for iPhones and the like—or simply omit coverage, and thus protection from areas where sensors may be located. As such, those films and rubber coverings do not allow for features such as fingerprint scanners (such as Apple's Touch ID) to work with the devices. In the case of the iPhone 5s, when current films are placed over the fingerprint sensor prevent, the sensor is prevented from accurately reading your fingerprint.

It is noted that in this disclosure and particularly in the claims and/or paragraphs, terms such as “comprises”, “comprised”, “comprising” and the like can have the meaning attributed to it in U.S. Patent law; e.g., they can mean “includes”, “included”, “including”, and the like; and that terms such as “consisting essentially of” and “consists essentially of” have the meaning ascribed to them in U.S. Patent law, e.g., they allow for elements not explicitly recited, but exclude elements that are found in the prior art or that affect a basic or novel characteristic of the invention.

### SUMMARY

It is an object of the current invention to provide full film coverage for the front of a portable device, while still allowing any touch identification technology (e.g., a fingerprint sensor) to operate and function properly. This object has been achieved by ensuring that the portion of the protective film which covers the touch identification sensor is thin enough to allow the sensor to properly register a user's touch so that the portable device can be operated.

### BRIEF DESCRIPTION OF THE DRAWINGS

FIGS. 1A to 1E show one embodiment of the protective film for a portable device;

FIGS. 2A and 2B show another embodiment of the protective film for a portable device; and

FIG. 2C shows close-up and cutaway views of the embodiment shown in FIGS. 2A and 2B;

FIGS. 3A and 3B show yet another embodiment of the protective film for a portable device; and

FIG. 3C shows another embodiment of the protective film for a portable device.

### DETAILED DESCRIPTION OF EMBODIMENTS

It is to be understood that the figures and descriptions of the present invention have been simplified to illustrate elements that are relevant for a clear understanding of the present invention, while eliminating, for purposes of clarity, many other elements which are conventional in this art. Those of ordinary skill in the art will recognize that other elements are desirable for implementing the present invention. However, because such elements are well known in the art, and because they do not facilitate a better understanding of the present invention, a discussion of such elements is not provided herein.

The present invention will now be described in detail on the basis of exemplary embodiments.

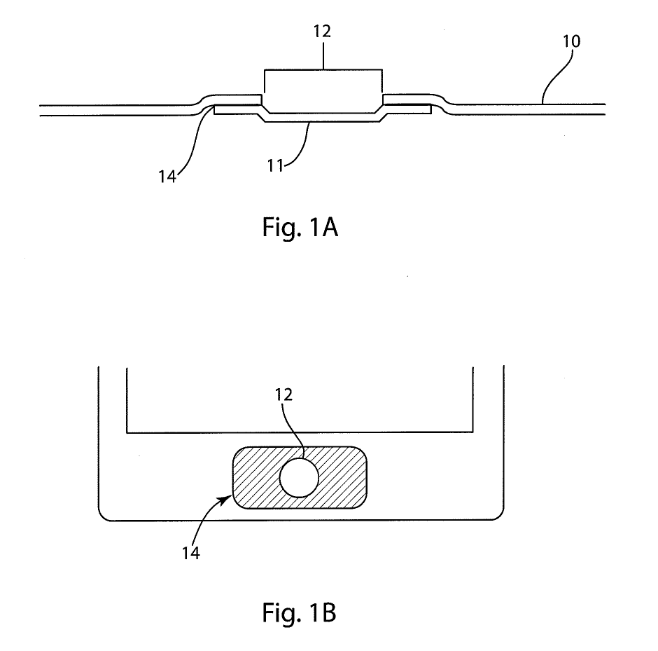

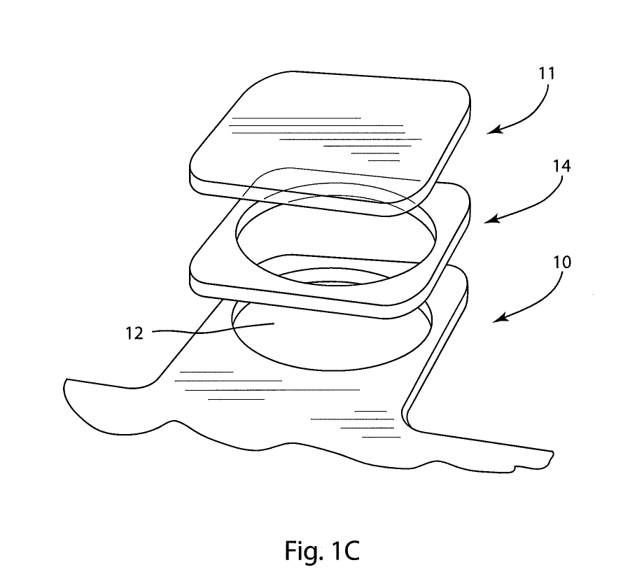

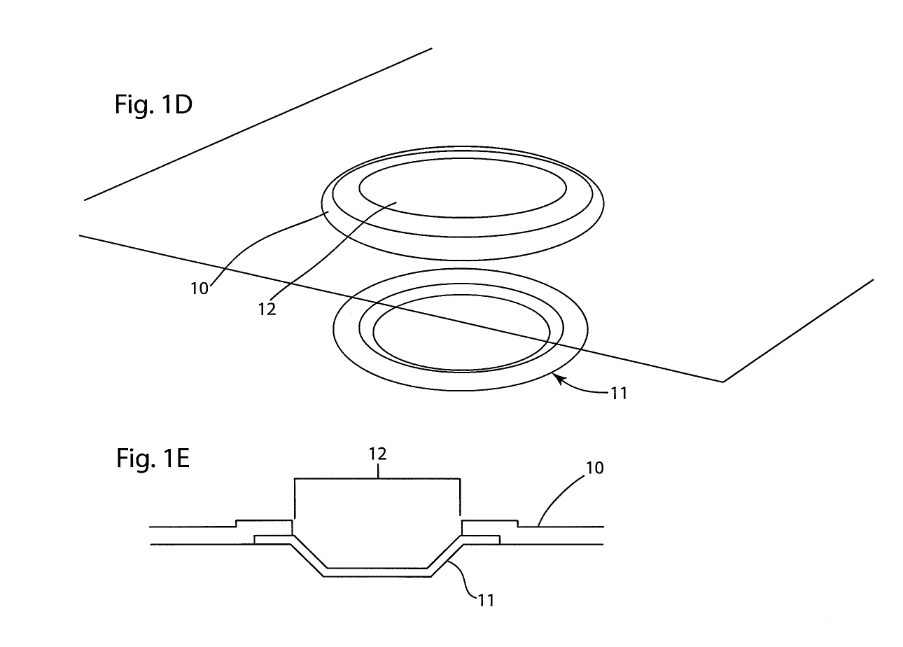

FIGS. 1A to 1E show an embodiment where a portion of a first film 10 configured to cover a portable device 20 has been cut away in a location to form an opening 12 corresponding to a touch identification sensor of the portable device. A second, thinner film 11 is then attached to the first film 10, so that the second film 11 is located in the area 12 corresponding to the touch identification sensor of the portable device. This attachment, for example to the underside of the first film 10, can be achieved by using an adhesive 14—such as an acrylic adhesive (e.g., VHB™), or any other suitable adhesive 14—between the two films. Both the thicker first film 10 and thinner second film 11 would be formed around the sensor (e.g., the Home button on an iPhone device) so that the thinner second film 11 would sit flush with the sensor 22.

Films with a thickness of 0.3 mm and greater are too thick to allow touch identification sensors to operate. Even films as thin as 0.15 mm, and some as thin as 0.12 mm, still prevent touch identification sensors from working. As such, the second film is configured with a thickness of less than 0.15 mm. Preferably the thickness of the second film is at least 0.04 mm and less than 0.12 mm. More preferably, the second film has a maximum thickness of 0.10 mm.

The second film can be made of any suitable transparent or sufficiently translucent film. Examples include clear plastics, such as polyethylene terephthalate (“PET”), polycarbonate (“PC”), polypropylene (“PP”), and acetate film.

PET films having thicknesses of 0.04 mm, 0.08 mm, and 0.10 mm were tested on the fingerprint identity sensor of the iPhone 5s, and all three films allowed the sensor to operate properly while still providing adequate protection for the area of the fingerprint identity sensor.

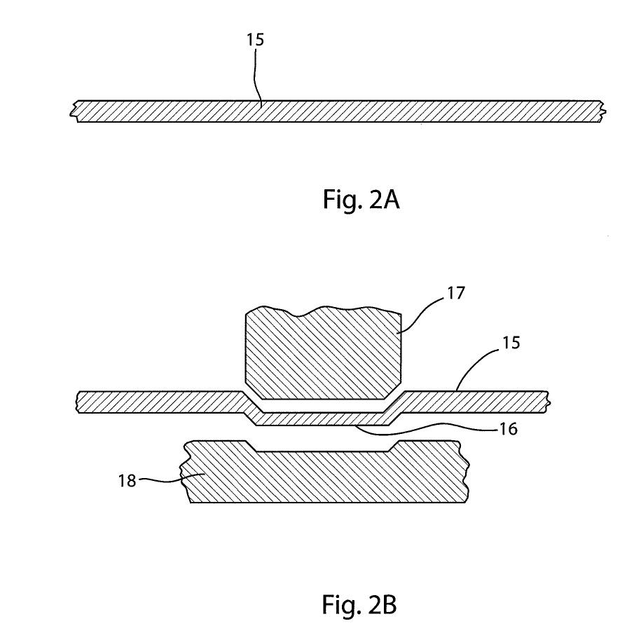

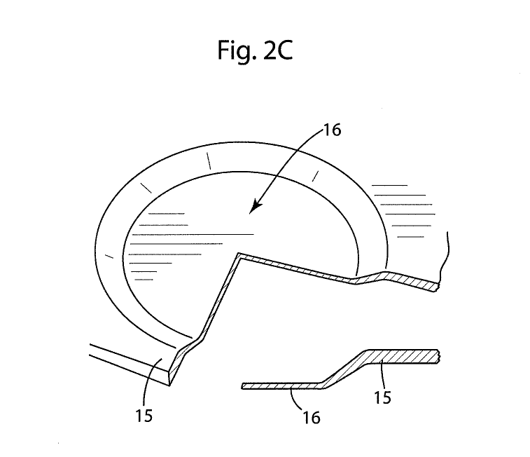

FIGS. 2A to 2C show an embodiment where a film 15 configured to cover a portable device is first formed with a thickness greater than 0.15 mm—in this case 0.3 mm. Then the protective film is compressed in an area 16 corresponding a touch identification sensor of the portable device, so that the compressed area 16 of the film has a thickness of less than 0.15 mm—in this case 0.10 mm or less. Zonal compression can be carried out by using methods such as, for example, employing a forming tool having male 17 and female compression 18 elements configured to compress the film in an area 16 corresponding a touch identification sensor of the portable device such that, for example, the compressed area 16 is flush with the sensor. This zonal compression provides a single-film cover for the portable device, as compared to the dual-film form of the embodiment shown in FIGS. 1A and 1B. As such, no adhesive is needed. The benefits of both embodiments are readily apparent to one of ordinary skill in the art.

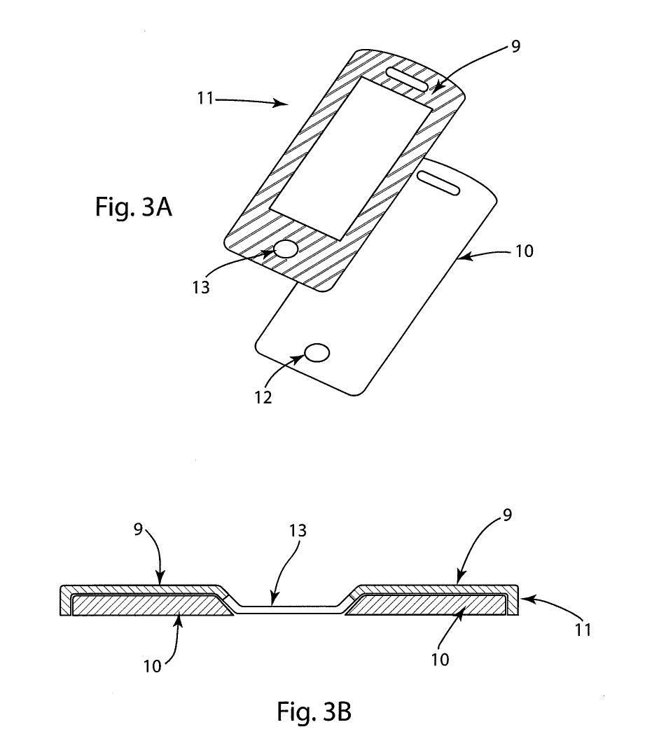

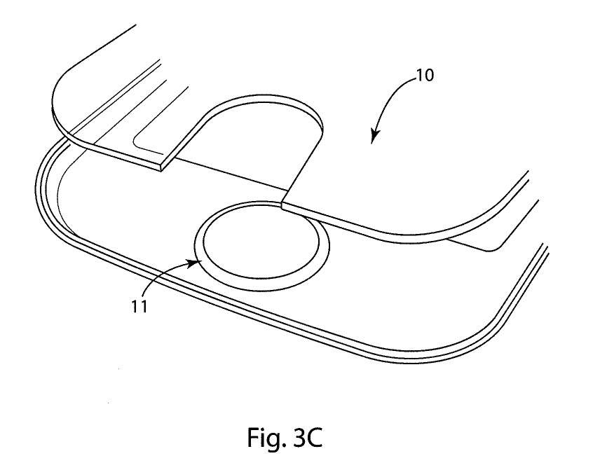

FIGS. 3A and 3B show another two-piece design for a protective film. In this embodiment, a first film which covers most of the portable device is formed. As in FIGS. 1A and 1B, at least a portion 12 of the first film 10 corresponding to the touch identification sensor has been cut away. A second film 11 is then formed to cover the front of the portable device except for the screen area. This second film 11 is formed so that at least the portion of second film 11 corresponding to the touch identification sensor has a thickness of less than 0.15 mm—in this case 0.10 mm or less. This can be achieved by forming the second film 11 to have a single thickness of less than 0.15 mm, or by forming the second film to have multiple thicknesses using any of the procedures discussed above with respect to FIGS. 1A-2B. The second film 11 can then be attached to either the front or the back of the first film—with FIGS. 3A and 3B showing the second film layered on top of the first film and FIG. 3C showing the second film 11 layered underneath the first film 10.

In addition, the portions 9 of the second film 11 which do not correspond to the touch identification sensor of the mobile device can be configured to be tinted or colored. For example these non-sensor areas can have a printed design or pattern—so long as a portion 13 of the second film 11 which corresponds to the sensor is clear, or sufficiently translucent to allow the touch identification sensor to function properly.

The above embodiments can be used to create individual screen protector devices, or can be incorporated into mobile device cases—including waterproof cases. In terms of an individual screen protector, the above embodiments provide both screen and button/sensor protection, while also allowing any sensors—including those incorporated into buttons—to sense fingerprints. In terms of a case with screen protection, it allows the case to be waterproof and to seal off front screen side buttons while allowing activation of a button's integrated touch identification sensor.

While this invention has been described in conjunction with the specific embodiments outlined above, it is evident that many alternatives, modifications, and variations will be apparent to those skilled in the art. Accordingly, the preferred embodiments of the invention as set forth above are intended to be illustrative, not limiting. Various changes may be made without departing from the spirit and scope of the inventions as defined in the following claims.

1. A protective film covering for a personal electronic device comprising:
one or more films having a first thickness and a second thickness that is less than the first thickness,
wherein the portion of the protective film covering including the second thickness is configured to align with and overlay a sensor of the personal electronic device so as to allow touch inputs to be transmitted to the sensor.

2. The protective film covering of claim 1 comprising:
a first film having the first thickness,
a second film attached to the first film and having the second thickness, the second film being thinner than the first film.

3. The protective film covering of claim 1, wherein the second film has a thickness of at least about 0.04 mm to less than about 0.12 mm.

4. The protective film covering of claim 3, wherein the second film has a thickness of about 0.10 mm.

5. The protective film covering of claim 3, wherein the second film has a thickness of about 0.08 mm.

6. The protective film covering of claim 3, wherein the second film has a thickness of about 0.04 mm.

7. The protective film covering of claim 2, further comprising:
the first film covering configured to at least partially cover a surface of the personal device having a screen area and the sensor, wherein the first film includes an opening for the sensor; and
the second film the is attached to the first film and configured to cover the front of the portable device except for the screen area.

8. The protective film covering of claim 7, wherein the second film is less than about 0.15 mm.

9. The protective film covering of claim 7, wherein the second film is less than about 0.10 mm.

10. The protective film covering of claim 2, wherein the second film is attached underneath the first film with respect to the personal electronic device.

11. The protective film covering of claim 2, wherein the second film is attached on top of the first film with respect to the personal electronic device.

12. The protective film covering of claim 1 wherein an area of the at least one film having the second thickness is a compressed area of the film.

13. The protective film covering of claim 12 wherein the protective film covering comprises a single film.

14. protective film covering of claim 13 wherein the first thickness is greater than about 0.15 mm and the second thickness is less than about 0.15 mm.

15. The protective film covering of claim 14 wherein the first thickness about 0.3 mm or more and the second thickness is about 0.10 mm or less.

16. The protective film covering of claim 1 wherein the film is configured to allow fingerprint inputs to be transmitted to a fingerprint sensor when the sensor is configured to include a fingerprint sensor.

17. The protective film covering of claim 1 wherein the portion of the film covering including the second thickness configured to align with and overlay a sensor of the personal electronic device comprises an area that is configured to be flush with the sensor.

18. A method of making protective film covering for a personal electronic device, the method comprising:
configuring a first film to at least partially cover a surface of a personal electronic device having a display and a sensor;
creating an opening in a first film corresponding the sensor of the personal electronic device; and
attaching a second film to the first film such that the second film aligns with and overlays the sensor, the second film being thinner than the first
wherein the second film is configured to allow inputs to be transmitted to the sensor.

19. The method of claim 18, wherein the second film has a thickness of at least about 0.04 mm to less than about 0.12 mm.

20. The method of claim 19, wherein the second film has a thickness of about 0.08 mm to 0.10 mm.

21. The method of claim 18, further comprising:
configuring the first film covering to at least partially cover a surface of the personal device having a screen area and the sensor, wherein the first film includes an opening for the sensor; and
attaching the second film to the first film to cover a front of the portable device except for the screen area.

22. The method of claim 21, wherein the second film is less than about 0.15 mm.

23. The method of claim 22, wherein the second film is less than about 0.10 mm.

24. The method of claim 21, wherein the second film is attached underneath the first film with respect to the personal electronic device.

25. The method of claim 21, wherein the second film the second film is attached on top of the first film with respect to the personal electronic device.

26. The protective film covering of claim 18 wherein the second film comprises an area that is configured to be flush with the sensor.

27. A method of making a protective film covering for a personal electronic device, the method comprising:
forming a film with a first thickness;
compressing an area of the film corresponding to a touch identification sensor of the personal electronic device such that the compressed area has a second thinness that is thinner than the first thickness and is configured to allow inputs to be transmitted to the touch identification sensor.

28. The method of claim 27, wherein the first thickness is greater than about 0.15 mm and the second thickness is less than about 0.15 mm.

29. The method of claim 27, wherein the first thickness about 0.3 mm or more and the second thickness is about 0.10 mm or less.

30. The method of claim 27 wherein the compressed area comprises an area that is configured to be flush with the sensor.
